(19) United States
(12) Patent Application Publication
(10) Pub. No.: US 2003/0033163 A1
(43) Pub. Date: Feb. 13, 2003

(54) Data modeling and attribute definition

(76) Inventors: Halim Habiby, Los Gatos, CA (US); Douglas A. Chuchro, San Francisco, CA (US); Richard J. Scott, Daly City, CA (US)

Correspondence Address: Philip M. Weiss, WEISS & WEISS, 500 OLD COUNTRY ROAD, GARDEN CITY, NY, 11530, US

(21) Appl. No.: 10/205,335

(22) Filed: Jul. 25, 2002

Related U.S. Application Data
(60) Provisional application No. 60/307,895, filed on Jul. 26, 2001.

(51) Int. Cl. G06F 17/60

(52) U.S. Cl. 705/1

(57) ABSTRACT

A system and method for defining attributes or specific characteristics, and attribute relevance for a universe of manufactured objects.

### FIELD OF THE INVENTION

The present invention relates to a system and method for defining attributes or specific characteristics, and attribute relevance for a universe of manufactured objects.

### BACKGROUND OF THE INVENTION

Wholesale level product distributors typically sell a wide range of similar products with dissimilar technical and aesthetic characteristics. Their products are supplied by multiple manufacturers. Furthermore, the technical and aesthetic characteristics that differentiate one product from another, often in a small or subtle way, are important considerations for the parties that must choose, purchase, install and repair those products.

### SUMMARY OF THE INVENTION

The present invention relates to a method for integrating multiple databases comprising retrieving information from a first database comprising product information from a manufacturer. The information is placed into a storage database into predetermined categories. These steps are repeated for other manufacturers of similar products. It is an object of the present invention for a user to be able to search the storage database by an attribute of the product. It is an object of the present invention for the system to update the product information for each particular manufacturer.

The present invention relates to a method for integrating multiple databases comprising inputting information comprising product information from a manufacturer. The information is placed into a storage database into predetermined categories. These steps are then repeated for other manufacturers of the product. It is an object of the invention for the system to allow a user to search the storage database by an attribute of the product. It is an object of the invention for the system to update the product information for a particular manufacturer.

The present invention relates to a system for storing information concerning a particular type of product produced by multiple manufacturers. The system comprises a database having numerous product details regarding each product. The database is searchable by the product details of the product. Other information can be stored in the database, but is not searchable by the user. It is an object of the present invention for the product details to comprise the manufacturer's name, base product identification, MSRP range, ADA compliant, application and color category. It is an object of the present invention for the products.to comprise bath controls, shower controls, faucet controls, sink controls, and toilet controls. It is an object of the present invention for the system to be able to place products found in a search side by side for comparison. It is an object of the present invention for the system to validate which products are compatible with other products. It is an object of the present invention for the system to update the product information periodically.

The present invention relates to a system and method of defining attributes, or specific characteristics, and attribute relevance for a universe of manufactured objects. This method can be a service for payment to those parties requesting a parametric electronic catalog for a given industry or industry segment.

The present invention relates to a system and method for standardizing classifications of manufactured objects, and the attributes and characteristics of those objects that have been created. Such standardized classifications, or models, are true and valid regardless of the source of the objects themselves. For example, similar products that are manufactured by different companies are entered and represented equally and uniformly in an electronic database. The tasks of product search, selection, comparison, compatibility checking and procurement are done through the database without regard to the ultimate source, or manufacturer, of a product.

In the present invention a manufacturer can enter information regarding their products into the database of the present invention or the system of the present invention can retrieve the information from a manufacturer's database. The system takes the information from a manufacturer's database and places the relevant information into predetermined categories in the database. Once the information is placed in the predefined categories, specific categories can be searched by a user. For example, the system will search for the name of the manufacturer and places it in the manufacturer category. Prices for the product will be placed in the MSRP category and divided by price range.

The standardization of the technical and aesthetic characteristics of products along pre-defined attributes allows products to be compared to one another without regard to source of the product itself. Furthermore, the technical characteristics that define each product may be related from one product to another, thus facilitating a process known as product configuration.

The present invention creates a set of parameters (or attributes) and rules that govern product relationships and interdependencies. Some examples of parameters include dimension, flow rate, finish, mount type, capacity, valve construction, building code compliance, color, weight, and price. Parameters are not specific to any product manufacturer. The present invention creates a de facto lingua franca for the products within each industry it targets.

The relationship rules inherent in each product family are applied across families to determine and validate which products are compatible with which other products. Some examples include whether a particular faucet and sink will fit together when installed, or whether a shower enclosure and a drain will fit together. In addition, rules for products that require the purchase of other products, or products that merely suggest the purchase of other products are also supported.

### BRIEF DESCRIPTION OF THE DRAWINGS

FIG. 1 is a model for Bath and Shower Modules

FIG. 2 is a model for Bath Tubs

FIG. 3 is a model for Bath and Shower Faucets

FIG. 4 is a model for Bath Faucets

FIG. 5 is a model for Shower Faucets

FIG. 6 is a model for Kitchen/Utility/Entertainment Faucets

FIG. 7 is a model for Lavatory Faucets

FIG. 8 is a model for Kitchen Sinks

FIG. 9 is a model for Lavatory Sinks

FIG. 10 is a model for Utility/Entertainment Sinks

FIG. 11 is a model for Toilets

### DETAILED DESCRIPTION OF THE INVENTION

The following example relates to a product comparison of the present invention. There are two plumbing products, lavatory faucets. These faucets are manufactured by two different companies; however, they appear similar in multiple ways. These faucets have attributes and characteristics that distinguish them from one another. Their attributes include, but are not limited to, faucet height, spout reach, number of handles, spread (distance between holes if any), mount type, list price, compliance with the Americans with Disabilities Act, finish and color. Because two faucets, manufactured by different companies, can each be represented in a database uniformly using the same technical and aesthetic attributes, they may be shown electronically, side by side. The characteristics of each faucet, although different, are shown for each faucet, thereby illustrating their differences.

The following example relates to a product configuration of the present invention. There are two classifications of manufactured plumbing products; one lavatory sink and one lavatory faucet. One attribute, or characteristic of the lavatory sink, among others, is the spread. This attribute represents the distance between the holes, if any, on the lavatory sink. On the other hand, one attribute, or characteristic of the lavatory faucet, is the spread. This attribute represents the distance between the holes, if any, that the faucet requires for installation with a particular lavatory sink. Because these two products, possibly manufactured by different companies, can each be represented in a database uniformly, they may also be related to another in the database. The spread attribute on a lavatory sink can be electronically linked to the spread attribute on a lavatory faucet, thereby ascertaining whether the products are compatible with one another. If the spread on the lavatory sink is eight inches, and the spread on the lavatory faucet is four inches, then the two products are not compatible with one another.

In a preferred embodiment the present invention includes a display mechanism for product attributes, as well as valid search values and search value types. For example, the Spout Height Range of a lavatory faucet is best represented by a drop down selectable “combo-type” box with valid alpha-numeric values of “5 inches or less”, “Greater than 5 inches”, or “All”. The number of handles on a lavatory faucet is best represented by a drop-down selectable “combo-type” box with valid integer values of “1,” “2,” or “Other”.

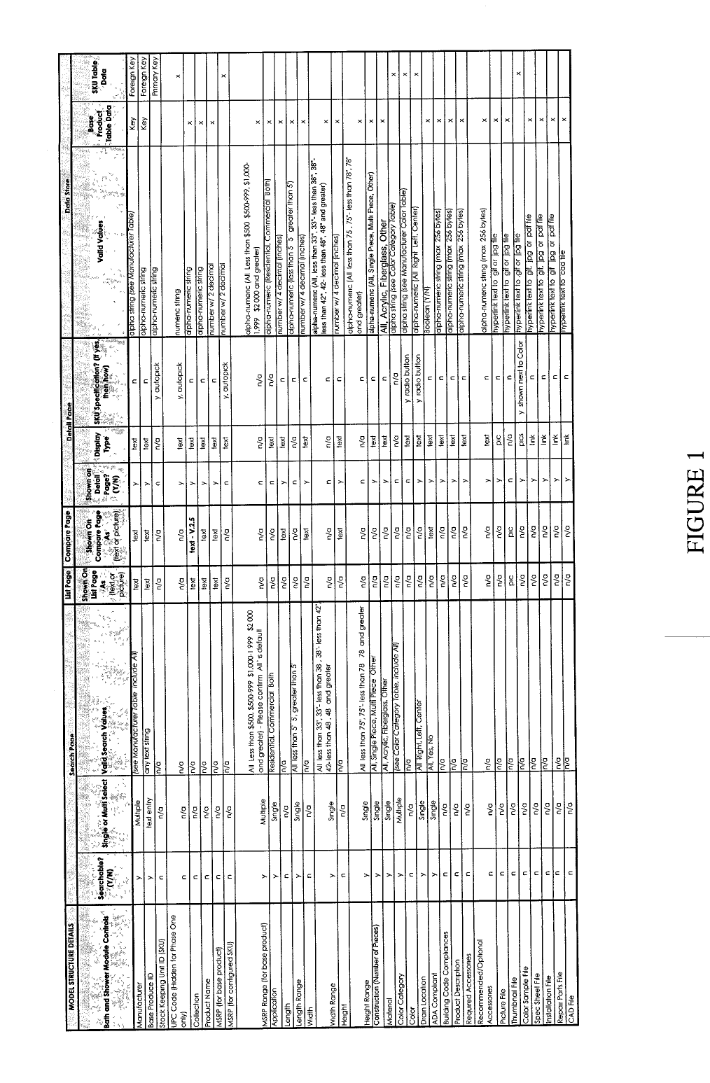

FIGS. 1-11 show examples of data models of the present invention for:

Bath and Shower Modules

Bath Tubs

Bath and Shower Faucets

Bath Faucets

Shower Faucets

Kitchen/Utility/Entertainment Faucets

Lavatory Faucets

Kitchen Sinks

Lavatory Sinks

Utility/Entertainment Sinks

Toilets

FIG. 1 shows a table concerning bath and shower module controls. The system takes information from various manufacturers of bath and shower module controls. The information is then placed into the database of the present invention and in one embodiment is broken down into the table shown in FIG. 1. For example, a manufacturer would have their name, base product identification, MSRP range, application, length range, width range, height range, number of pieces, material, color category, drain location, ADA compliant; all of which are searchable in the database. In this system the user can search by manufacturer to see all the products which are manufactured by that company regarding bath and shower module controls. A user can search by MSRP range. For example, a user can search for prices less than $500, between $500-$999 dollars, between $1,000-$1,999 and between $2,000 and greater. By picking a value range a user can find all products which are available for all manufacturers in that price range. Other searchable categories can be searched in the same way. Therefore the invention provides a database which groups information between multiple manufacturers who have listed their information in different forms providing a database to a user from which a user can search multiple manufacturers. Although the database is only searchable for certain categories, other information can be found for each product and provided to the user.

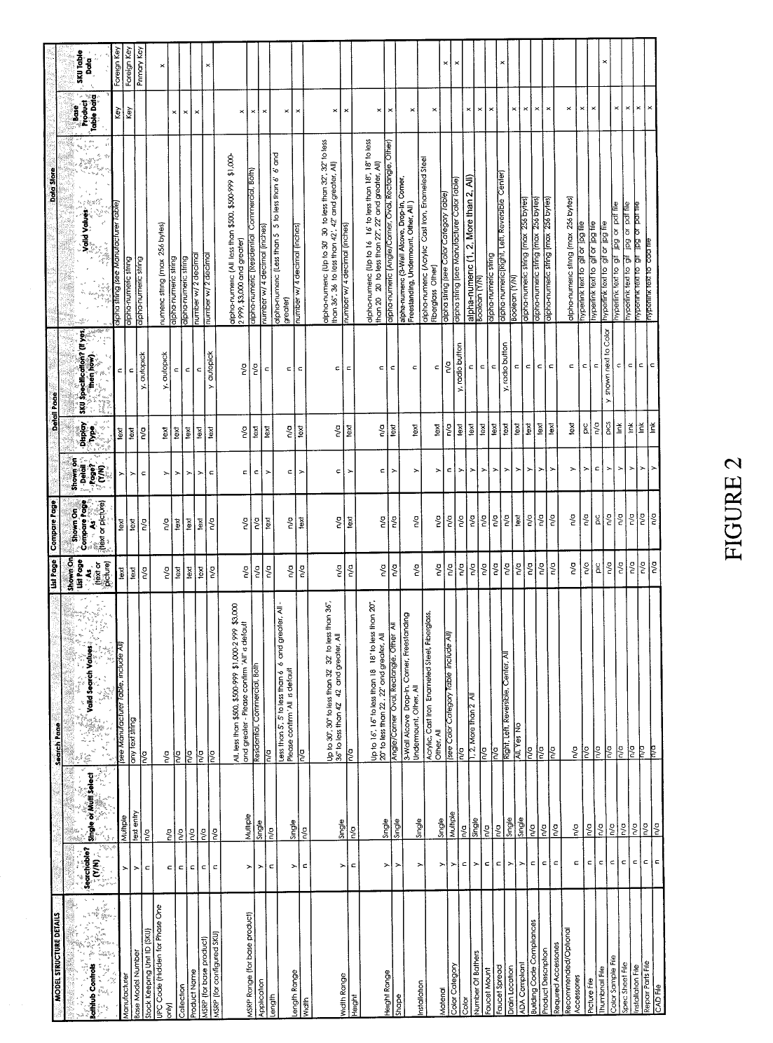

FIG. 2 illustrates a database regarding bathtub controls. The database is searchable by manufacturer, base product identification, MSRP range, application, length range, width range, height range, shape, installation, material, color category, number of bathers, drain location and ADA compliant. In an embodiment of the present invention, the user can search through information from multiple manufacturers from a single search engine regarding bathtub controls.

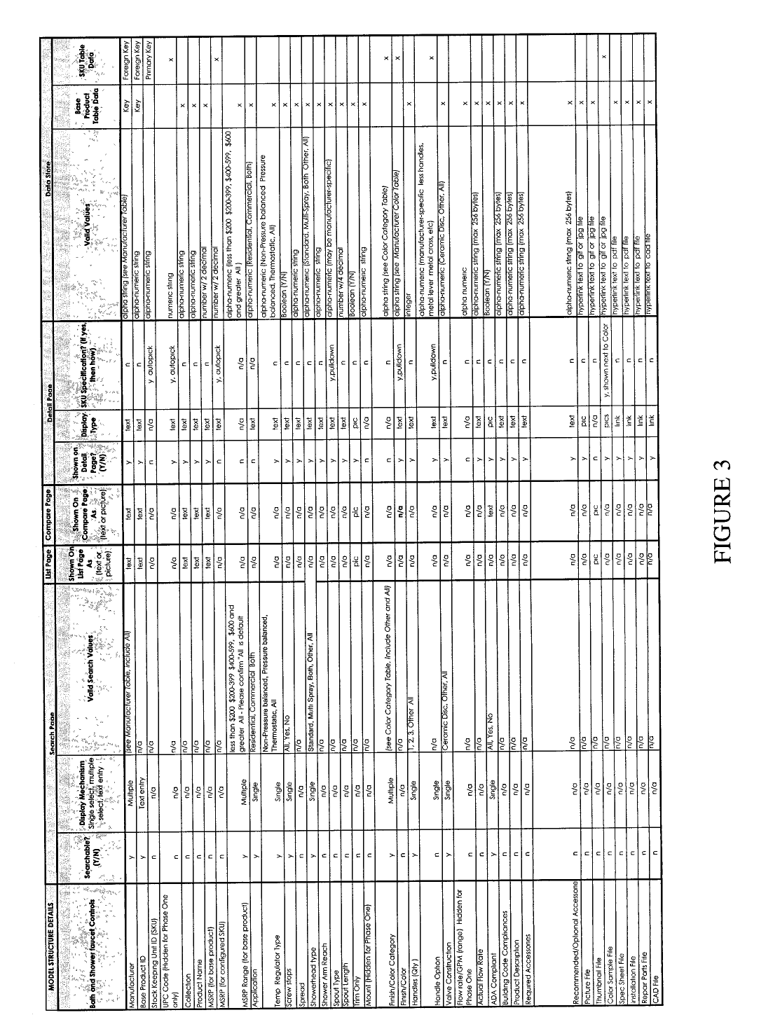

FIG. 3 illustrates a database regarding bath and shower faucet controls. The database is searchable by manufacturer, base product ID, MSRP Range (for base product), application, temperature regulatory type, screw stops, showerhead type, finish/color category, handles (Qty.), valve construction and ADA compliant. In an embodiment of the present invention, the user can search through information from multiple manufacturers from a single search engine regarding bath and shower faucet controls.

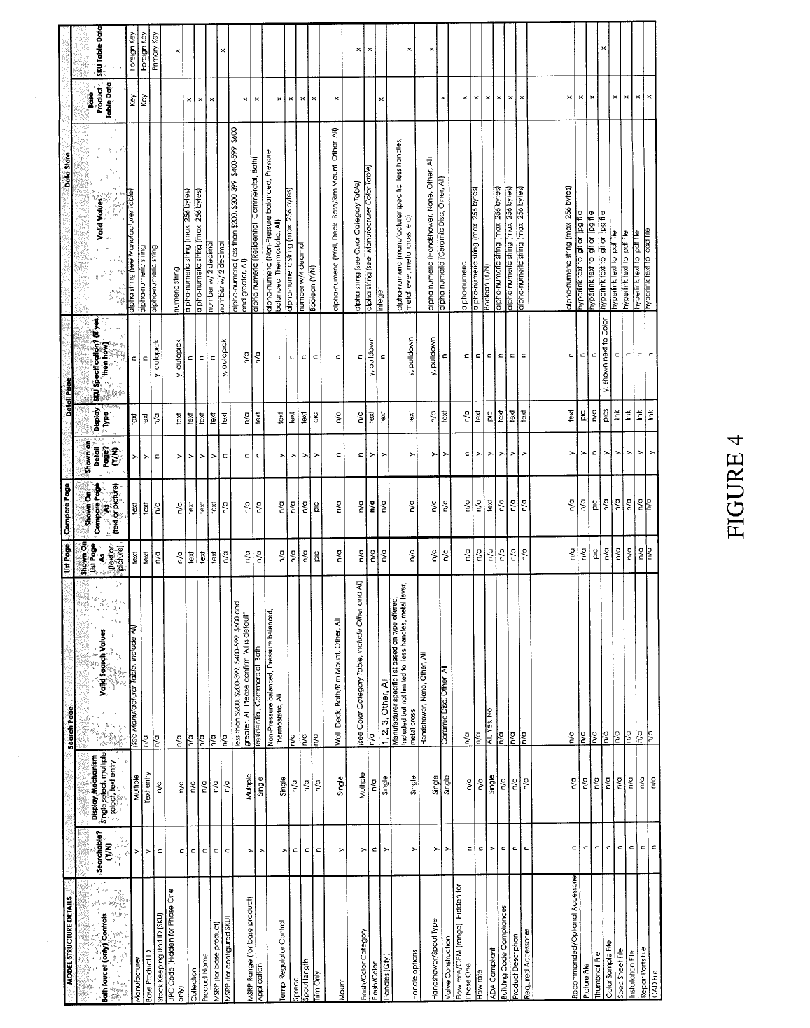

FIG. 4 illustrates a database regarding bath faucet (only) controls. The database is searchable by manufacturer, base product ID, MSRP range (for base product), application, temperature regulator control, mount, finish/color category, handles (Qty.), handle options, hand shower, valve construction properties and ADA compliant. In an embodiment of the present invention, the user can search through information from multiple manufacturers from a single search engine regarding bath faucet (only) controls.

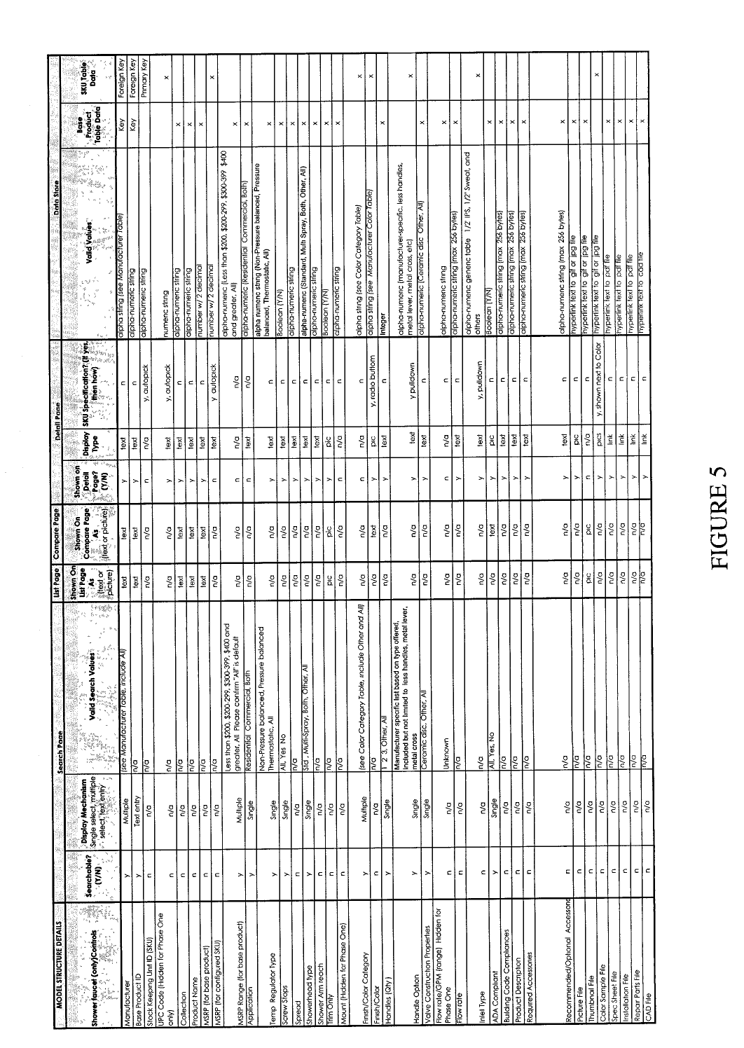

FIG. 5 illustrates a database regarding shower faucet (only) controls. The database is searchable by manufacturer, base product ID, MSRP Range (for base product), application, temperature regulator type, screw stops, showerhead type, finish/color category, handles (Qty.), handle option, valve construction properties and ADA compliant. In an embodiment of the present invention, the user can search through information from multiple manufacturers from a single search engine regarding shower faucet (only) controls.

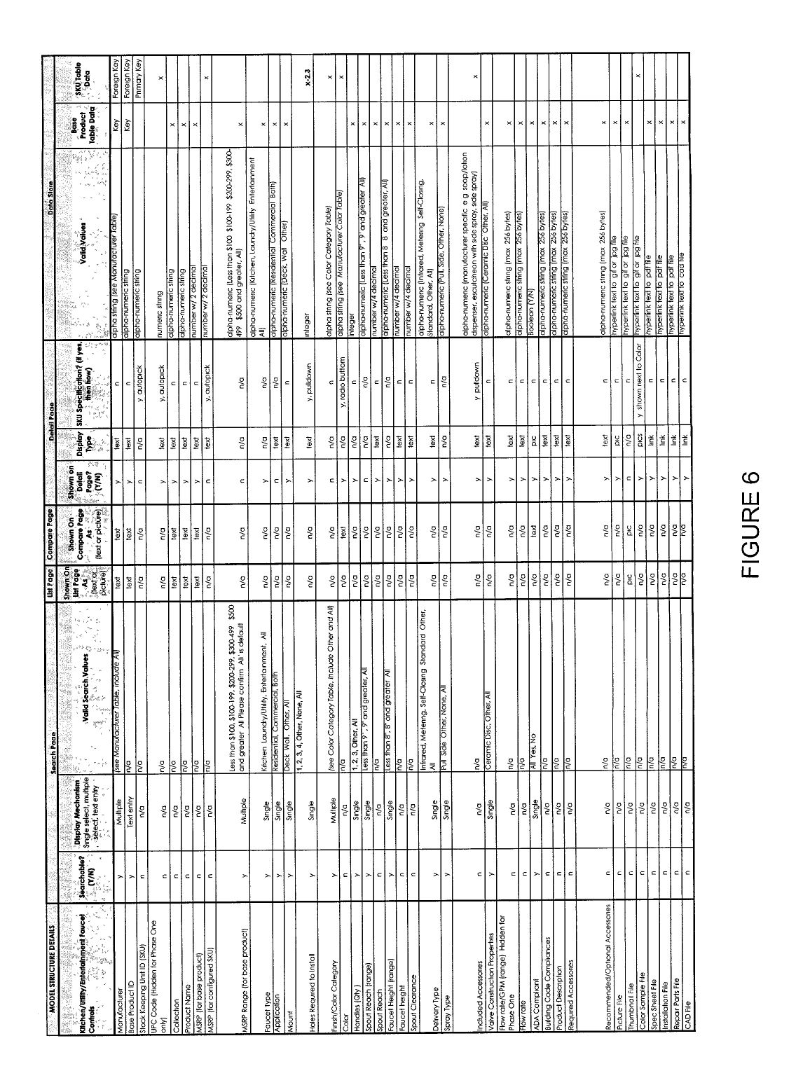

FIG. 6 illustrates a database regarding kitchen/utility/entertainment faucet controls. The database is searchable by manufacturer, base product ID, MSRP Range (for base product), faucet type, application, mount, holes required to install, finish/color category, handles (Qty.), spout reach (range), faucet height (range), delivery type, sprayer type, valve construction properties, and ADA compliant. In an embodiment of the present invention, the user can search through information from multiple manufacturers from a single search engine regarding kitchen/utility/entertainment faucet controls.

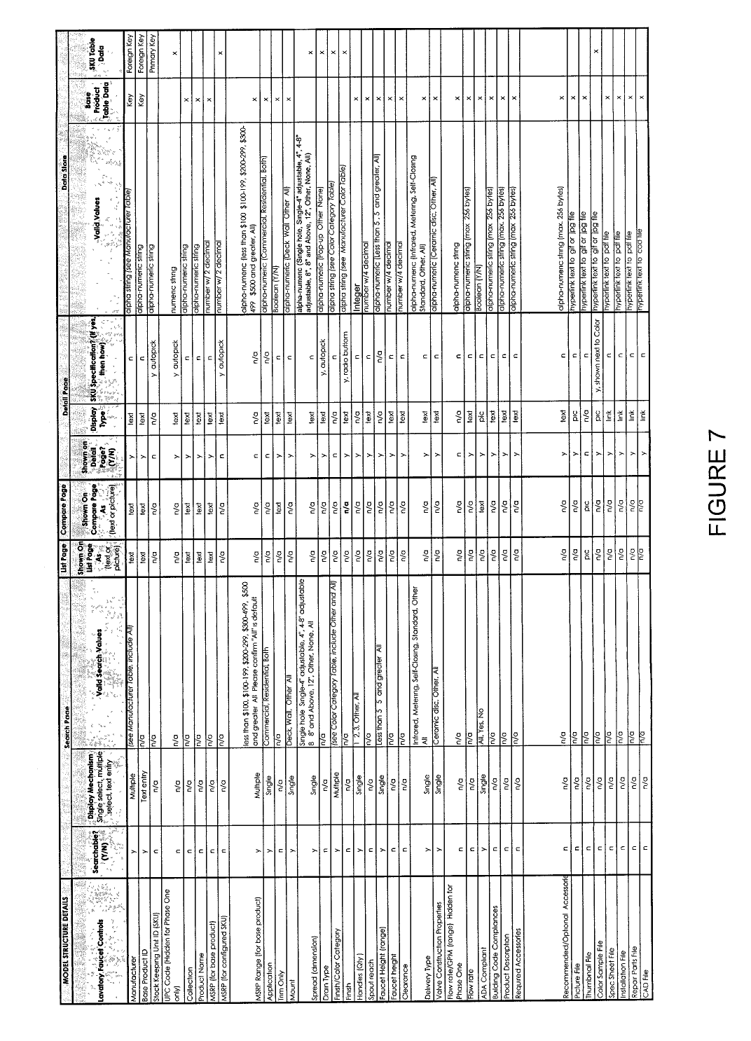

FIG. 7 illustrates a database regarding lavatory faucet controls. The database is searchable by manufacturer, base product ID, MSRP range (for base product), application, mount, spread (dimension), finish/color category, handles (Qty.), faucet height (range), delivery type, valve construction properties and ADA compliant. In an embodiment of the present invention, the user can search through information from multiple manufacturers from a single search engine regarding lavatory faucet controls.

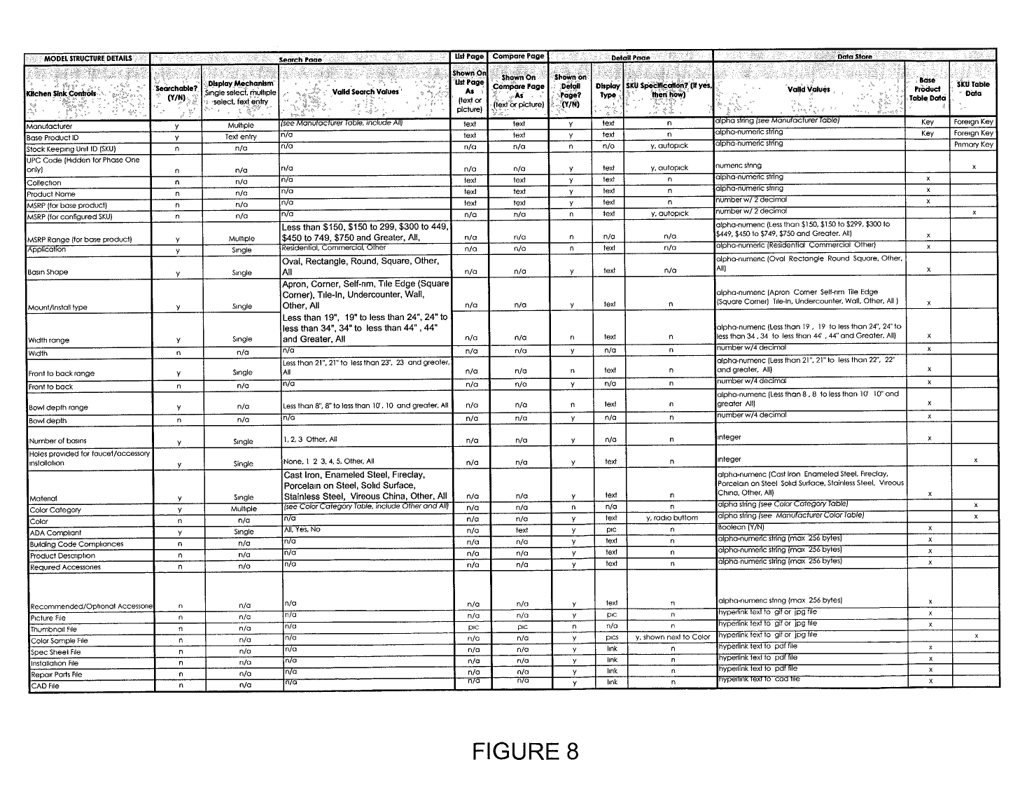

FIG. 8 illustrates a database regarding kitchen sink controls. The database is searchable by manufacturer, base product ID, MSRP range (for base product), application, basin shape, mount/install type, width range, front to back range, bowl depth range, number of basins, holes provided for faucet/accessory installation, material, color category and ADA compliant. In an embodiment of the present invention, the user can search through information from multiple manufacturers from a single search engine regarding kitchen sink controls.

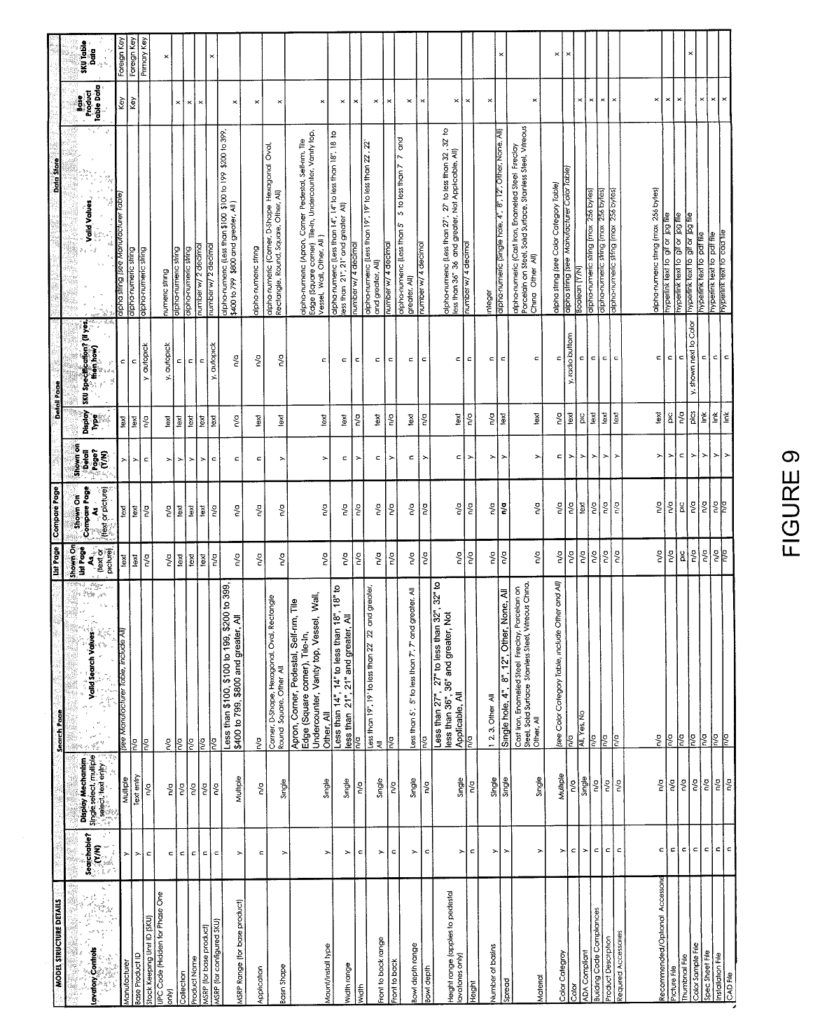

FIG. 9 illustrates a database regarding lavatory controls. The database is searchable by manufacturer, base product ID, MSRP Range (for base product), basin shape, mount/install type, width range, front to back range, bowl depth range, height range (applies to pedestal lavatories only), number of basins, spread, material, color category and ADA compliant. In an embodiment of the present invention, the user can search through information from multiple manufacturers from a single search engine regarding lavatory controls.

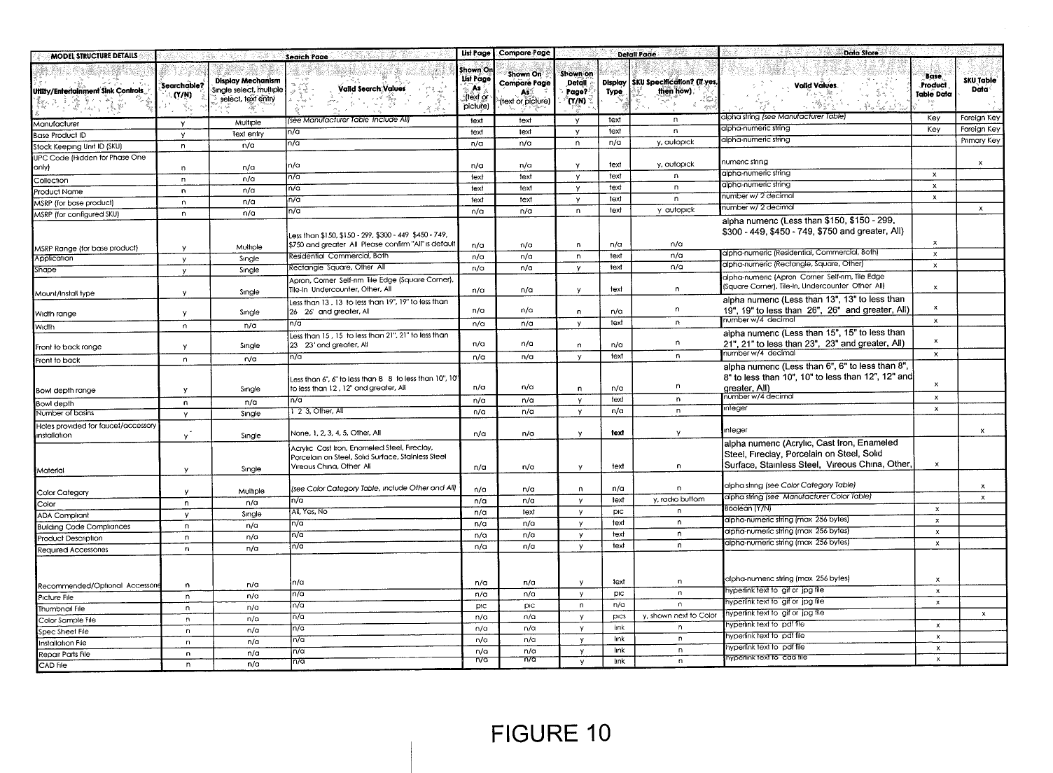

FIG. 10 illustrates a database regarding utility/entertainment sink controls. The database is searchable by manufacturer, base product ID, MSRP range (for base product), application, shape, mount/install type, width range, front to back range, bowl depth range, number of basins, holes provided for faucet/accessory installation, material, color category and ADA compliant. In an embodiment of the present invention, the user can search through information from multiple manufacturers from a single search engine regarding utility/entertainment sink controls.

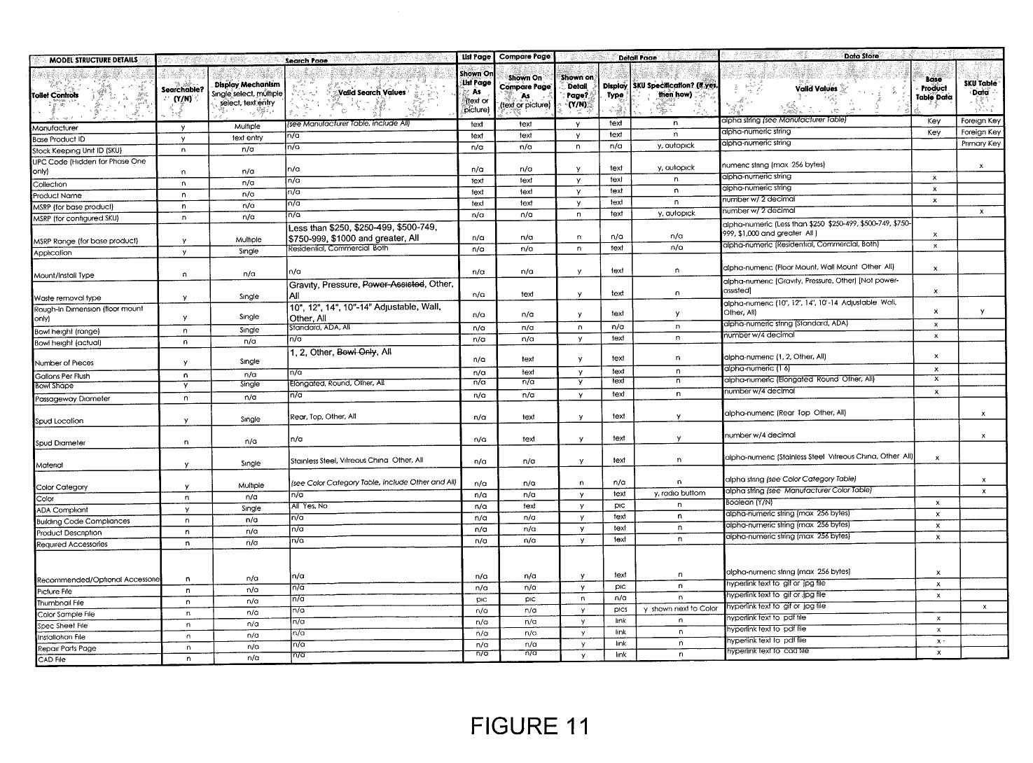

FIG. 11 illustrates a database regarding toilet controls. The database is searchable by manufacturer, base product ID, MSRP range (for base product), application, waste removal type, Rough-In dimension (floor mount only), number of pieces, bowl shape, spud location, material, color category and ADA compliant. In an embodiment of the present invention, the user can search through information from multiple manufacturers from a single search engine regarding toilet controls.

1. A method for integrating multiple databases comprising:
retrieving information from a first database comprising product information from a manufacturer;
placing said information into a storage database into predetermined categories;
performing steps one and two for other manufacturer's of said product.

2. The method of claim 1 further comprising searching said storage database by an attribute of said product.

3. The method of claim 1 further comprising updating said product information for a particular manufacturer.

4. A method for integrating multiple databases comprising:
inputting information comprising product information from a manufacturer;
placing said information into a storage database into predetermined categories;
performing steps one and two for other manufacturer's of said product.

5. The method of claim 4 further comprising searching said storage database by an attribute of said product.

6. The method of claim 4 further comprising updating said product information for a particular manufacturer.

7. A system for storing information concerning a particular type of product produced by multiple manufacturers comprising;
a database having numerous product details regarding said product;
said database being searchable by said product details of said product;
other information being stored in said database but not being searchable.

8. The system of claim 7 wherein said product details comprise manufacturer's name, base product identification, MSRP range, ADA compliant, application and color category.

9. The system of claim 7 wherein said products comprise bath controls, shower controls, faucet controls, sink controls, and toilet controls.

10. The system of claim 7 wherein said system can place products found in a search side by side for comparison.

11. The system of claim 7 wherein said system validates which products are compatible with other products.

12. The system of claim 5 wherein said system updates said product information periodically.
